(19) United States
(12) Patent Application Publication
(10) Pub. No.: US 2011/0266240 A1
(43) Pub. Date: Nov. 3, 2011

(54) MODULAR MATERIAL HANDLING SYSTEM

(76) Inventor: LARRY JONES, VANCOUVER, WA (US)

(21) Appl. No.: 13/015,530

(22) Filed: Jan. 27, 2011

Related U.S. Application Data
(60) Provisional application No. 61/299,861, filed on Jan. 29, 2010.

(51) Int. Cl. B66C 23/18; B66C 23/16

(52) U.S. Cl. 212/179

(57) ABSTRACT

A modular material handling system includes a base portion removably connectable to a machine tool frame, the base portion including a hollow stanchion with a first end to go against a machine frame coupled to a compression plate by a threaded mounting stud and a second end to couple to a hollow pivot post coupled by a thrust bearing, with a shaft extending through the stanchion and pivot post and coupled at a lower end to the mounting stud and at an upper end to a retaining nut, and further including an arm extending from the pivot post to carry a movable shuttle and lifting mechanism.

### CROSS REFERENCE TO RELATED APPLICATIONS

This application claims priority to U.S. Provisional Patent Application Ser. No. 611299,861. filed Jan. 29, 2010, which is hereby incorporated by reference into this application.

### FIELD OF THE INVENTION

The present invention relates to improvements to material handling systems. More particularly, the present invention relates to a modular material handling system mountable to a stand alone machine in a machine shop or field worksite.

### BACKGROUND

Persons working in small machine shops, or at temporary job sites in the field, often face severe ergonomic problems and workplace safety concerns due to the limited space available in the shop compared to the foot print of material handling equipment. Workers and hobbyists frequently must load heavy work pieces, such as metal shafts, motors, engine blocks, axels, & etc, onto the operating tables of stand alone machine tools such as milling machines, band saws, drill presses, and similar machines. However, limited shop space often prevents the use of portable lifts, which require wide bases for stability, to assist in placing heavy loads on the machine table, or in supporting and feeding heavy loads across the machine table. Gantry cranes may also be used, but are expensive and often require structural modifications to the shop building in order to mount. Even so, the range of motion of a typical gantry system is often very limited because the track system supporting the crane must be directly over the lift and placement spots.

Feeding large work pieces, such as beams, pipes or shafts across a machine table can also be very problematic—for example, when milling a long keyway or channel along a long pump shaft. The work piece must be firmly supported at the free end to prevent twisting, pitching, rolling, and other out-of-axis movement, and the support system must move with the work piece as it moves across the machine table to ensure a clean, aligned cut. Often, a worker will try to “jerry rig” work benches or tables abutting the machine table, but the work benches may not be the correct height or length. The work bench surface may not be conducive to pushing work piece across its surface. Furthermore, such work benches and tables can interfere with the worker properly positioning himself or herself to guide the work piece and operate the machine, and they take up a great deal of shop floor footprint when not in use.

Thus, there is a need for material handling apparatus and methods which provide the ability to assemble in a machine shop and mount directly to the frame of a machine, and which can provide both lifting support and the ability to feed material across a machine table. There is a need for material handling apparatus and methods which are modular so as to be easily assembled and disassembled within a machine shop or at a temporary job site, and which are relatively inexpensive so as to be accessible for small machine shop owners and hobbyists.

### SUMMARY AND ADVANTAGES

A modular material handling system, includes a base portion removably connectable to a machine tool frame, the base portion including a hollow stanchion having opposing first and second flanged ends and a first centerline channel extending there between, the first flanged end further having a central circular through passage and a face configured to receive a thrust bearing, the second flanged end to go against a portion of the machine frame and further including a closed end plate having a first receiving hole there through with diameter less than a main shaft diameter; a stanchion main shaft upper bushing to insert into the stanchion first end central through passage; a bottom compression plate to go against a portion of the machine frame in opposing manner to the stanchion second flanged end, the bottom compression plate having a second receiving hole there through; an elongated mounting stud having opposing first and second threaded ends, the mounting stud to insert through the first and second receiving holes and the machine frame portion; and, a base compression nut to couple to the mounting stud second threaded end against the bottom compression plate; a pivot post assembly to couple to the stanchion, the pivot assembly comprising a hollow pivot post having opposed first and second flanged ends and a second centerline channel extending there between, each of the first and second pivot post flanged ends including a central circular through passage, and the second pivot post flanged end further including a face configured to receive a thrust bearing; and first and second pivot post main shaft bushings insertable into the first and second pivot post central through passages, respectively; a thrust bearing to couple the base portion and the pivot post assembly between the stanchion first flange face and the pivot post second flange face; an elongated main shaft having a first end with opposing flats, a second end with a female threaded hole, and a circular cross section, the main shaft to insert through the first and second centerline channels within the main shaft bushings and the shaft second end going against the stanchion end plate to couple the female threaded hole with the mounting stud first threaded end through the first receiving hole, the shaft first end extending beyond the pivot post first end; a thrust washer to insert over the man shaft first end onto the pivot post first flanged end and the main shaft bushing within the pivot post first flanged end through passage; a set collar to insert over the main shaft first end against the thrust washer and secure to the main shaft; and, an elongated arm to rigidly couple to the pivot post so as to extend substantially normal from the pivot post, the elongated arm to receive a shuttle. A modular material handling system, includes a shuttle movably coupled to the arm, the shuttle movable along at least a portion of the length of the arm, the shuttle configured to receive a load lifting mechanism. A modular material handling system, includes a linear rail mounted along at least part of the length of the elongated arm, wherein the shuttle is mounted to the linear rail to move along the linear rail. 4 A modular material handling system, includes a lifting mechanism coupled to the shuttle. A modular material handling system, includes one or more gusset arms to couple between the elongated arm and the pivot post. A modular material handling system, includes wherein the base portion further comprises a stanchion main shaft lower bushing to insert into the first centerline channel against the end plate and to receive the main shaft second end therein.

The material handling system of the present invention presents numerous advantages, including: (1) it is directly mountable to an existing milling machine; (2) it is modular so may be detached and disassembled; (conserves floor space in machine shop areas: (3) provides for safer handling in small machine shops; (4) it is simple and rugged; (5) provides for even feeding of linear loads through a milling machine.

The simple, rugged and modular design of the material handling system present many advantages over existing systems, and provide a system that is optimized for small shops and field use where so many injuries occur. Additional advantages of the invention will be set forth in part in the description which follows, and in part will be apparent from the description, or may be learned by practice of the invention. The advantages of the invention may be realized and attained by means of the instrumentalities and combinations particularly pointed out in the appended claims. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

FIG. 1 shows a side view of an embodiment of a material handling system mounted to a stand-alone milling machine.

FIG. 2 shows a view of a portion of a base of an embodiment of a material handling system mounted to a stand-alone milling machine.

FIG. 3 shows a schematic view of the internal portions of an embodiment of a material handling system.

FIG. 3A shows a detail cross-section of the stanchion-to-pivot post coupling.

FIG. 3B shows a detail cross-section of the pivot post first end assembly.

FIG. 4 shows a bottom plate of an embodiment of a material handling system.

FIG. 4A shows a side view of a bottom plate of an embodiment of a material handling system.

FIG. 4B shows a plan view of a bottom plate of an embodiment of a material handling system.

FIG. 5 shows a main shaft of an embodiment of a material handling system.

FIG. 5A shows a side view of a main shaft of an embodiment of a material handling system.

FIG. 5B shoes a top end view of a main shaft of an embodiment of a material handling system.

FIG. 6 shows a pivot post flange of an embodiment of a material handling system.

FIG. 6A shows a side view of a pivot post flange of an embodiment of a material handling system.

FIG. 6B shows a plan view of a pivot post flange of an embodiment of a material handling system.

FIG. 7 shows a thrust washer of an embodiment of a material handling system.

FIG. 7A shows a side view of a thrust washer of an embodiment of a material handling system.

FIG. 7B shows a plan view of a thrust washer of an embodiment of a material handling system.

FIG. 8 shows a mounting stud of an embodiment of a material handling system.

FIG. 8A shows a side view of a mounting stud of an embodiment of a material handling system.

FIG. 8B shows an end view of a amounting stud of an embodiment of a material handling system.

FIG. 9 shows a stanchion bottom flange of an embodiment of a material handling system.

FIG. 9A shows a side view of a stanchion bottom flange of an embodiment of a material handling system.

FIG. 9B shows a plan view of a stanchion bottom flange of an embodiment of a material handling system.

FIG. 10 shows a stanchion upper flange of an embodiment of a material handling system.

FIG. 10A shows a side view of a stanchion upper flange with a thrust bearing of an embodiment of a material handling system.

FIG. 10B shows a cutaway side view of a stanchion upper flange, without a thrust bearing of an embodiment of a material handling system.

FIG. 10C shows a plan view of a stanchion upper flange of an embodiment of a material handling system.

FIG. 11 shows a stanchion tube of an embodiment of a material handling system.

FIG. 11A shows a side view of a stanchion tube of an embodiment of a material handling system.

FIG. 11B shows an end view of a stanchion tube of an embodiment of a material handling system.

FIG. 12 shows a shaft bushing of an embodiment of a material handling system.

FIG. 12A shows a side view of a bushing of an embodiment of a material handling system.

FIG. 12B shows a plan view of a bushing of an embodiment of a material handling system.

FIG. 13 shows a pivot post assembly of an embodiment of a material handling system.

FIG. 13A shows a side view of a pivot post assembly of an embodiment of a material handling system.

FIG. 13B shows a different side view of a pivot post assembly of an embodiment of a material handling system.

FIG. 14 shows a plan view of an embodiment of a material handling system.

### REFERENCE NUMBERS USED IN DRAWINGS

Turning now descriptively to the drawings, in which similar reference characters denote similar elements throughout the several views, the figures illustrate the material handling system of the present invention, With regard to the reference numerals used, the following numbering is used throughout the various drawing figures:

Item Number Description

100 Embodiment

110 Base Portion

112 Stanchion

114 Bottom Plate

116 Mounting Stud

118 Base Nut

120 Stanchion Tube First End

122 Stanchion Tube Second End

124 Stanchion Tube Centerline Channel

126 Mounting Stud First Threaded Portion

128 Mounting Stud Second Threaded Portion

130 Stanchion Bottom Range

132 Female Threaded Hole

134 Stanchion Tube

136 (not used)

138 Stanchion Upper Range

140 Upper Range First Face

142 Upper Range Second Face

144 Bearing Race

146 Bearing

148 Upper Range Center Hole

150 Main Shaft

152 Main Shaft First End

154 Main Shaft Second End

156 Rats

158 Pivot Post

160 Pivot Post Tube

162 Pivot Post Tube First End

164 Pivot Post Tube Second End

166 First End Range

168 Second End Range

170 First End Flange inner Diameter

172 Second End Range Inner Diameter

174 First Flange Thickness

176 Second Flange Thickness

178 Pivot Post Upper Main Shaft Bushing

180 Shaft Bushing Depth

182 Shaft Bushing Outer Diameter

184 Shaft Busing Inner Diameter

186 Main Shaft Outer Diameter

188 Set Collar

190 Jib Arm

192 Back Strap

194 Jib Arm Mounting Plate

196 Linear Rail

198 Shuttle

200 Lifter

202 Lifter Locking Hook

204 Load Handler

206 Flexible Connector

208 Load Handler Locking Hook

210 Thrust Washer

212 Gusset Arms

214 Main Shaft Threaded Bore

216 Jib Arm Mounting Flange

218 Bolt Holes

220 Bottom Plate Hole

222 Pivot Post Centerline Channel

224 Stanchion Main Shaft Upper Bushing

M Machine tool

A Oiler ring

F Machine tool frame

H Machine tool head

T Machine tool table

### DETAILED DESCRIPTION

Before beginning a detailed description of the subject invention, mention of the following is in order. When appropriate, like reference materials and characters are used to designate identical, corresponding, or similar components in differing figure drawings. The figure drawings associated with this disclosure typically are not drawn with dimensional accuracy to scale, i.e., such drawings have been drafted with a focus on clarity of viewing and understanding rather than dimensional accuracy.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

A material handling system includes a base portion connectable to a machine tool frame, a pivot post rotatably connectable to said base portion, an arm connectable to said pivot post so as to extend horizontally from said base portion; a shuttle movably mounted to said arm, said shuttle movable along at least a portion of the length of said arm; a lifter connectable to said shuttle; and, a load handler flexibly connectable to said lifter.

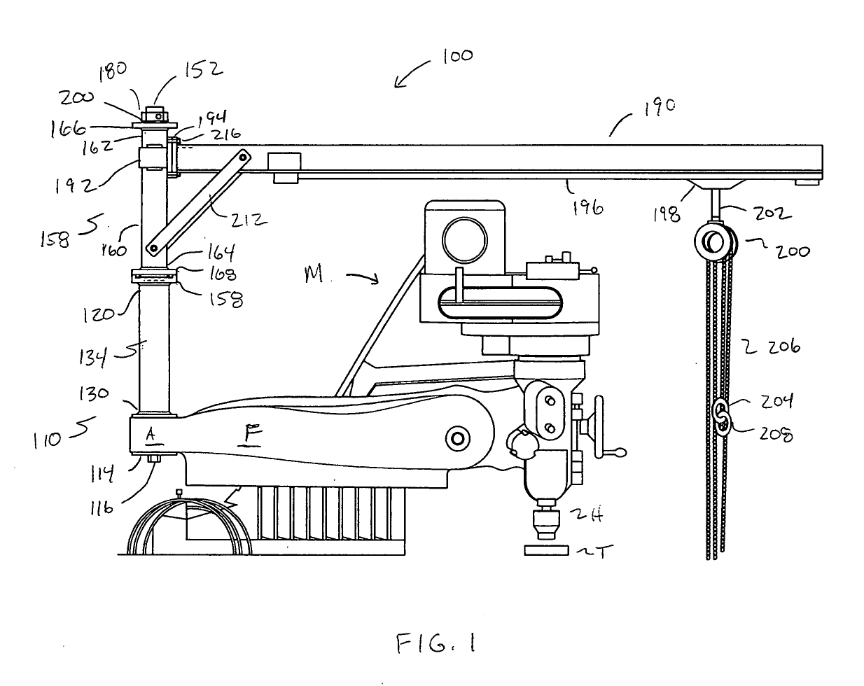

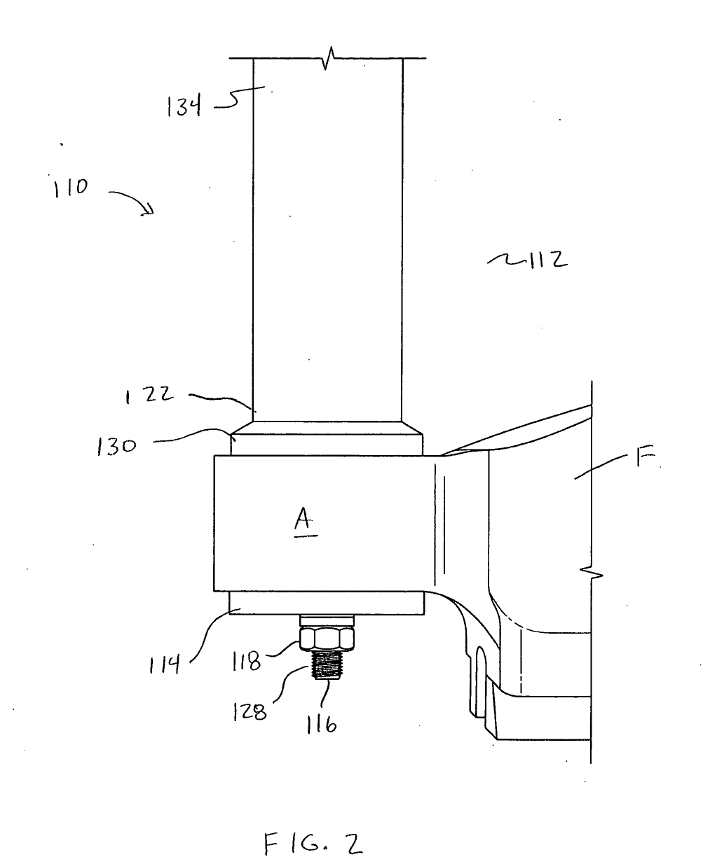

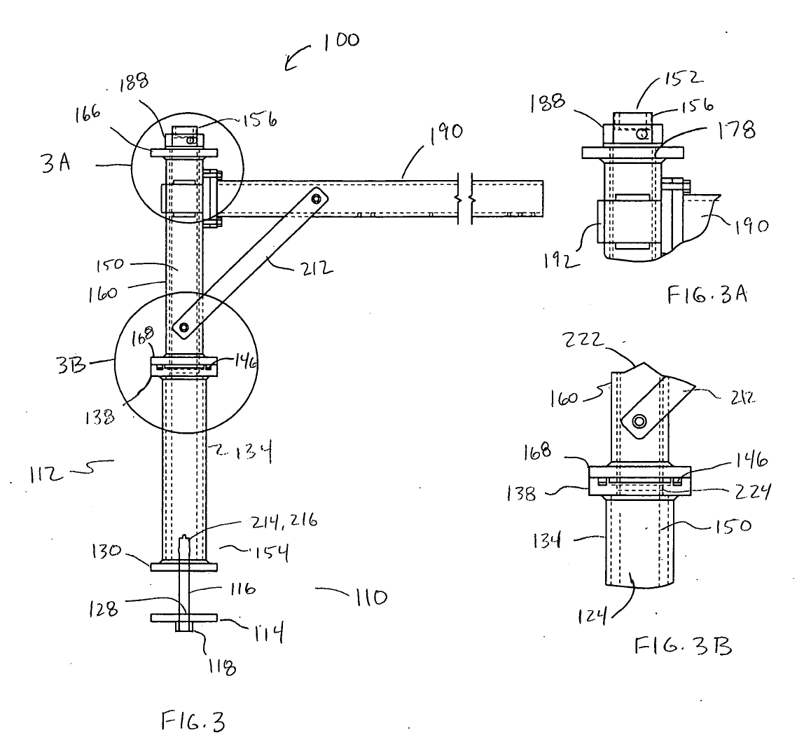

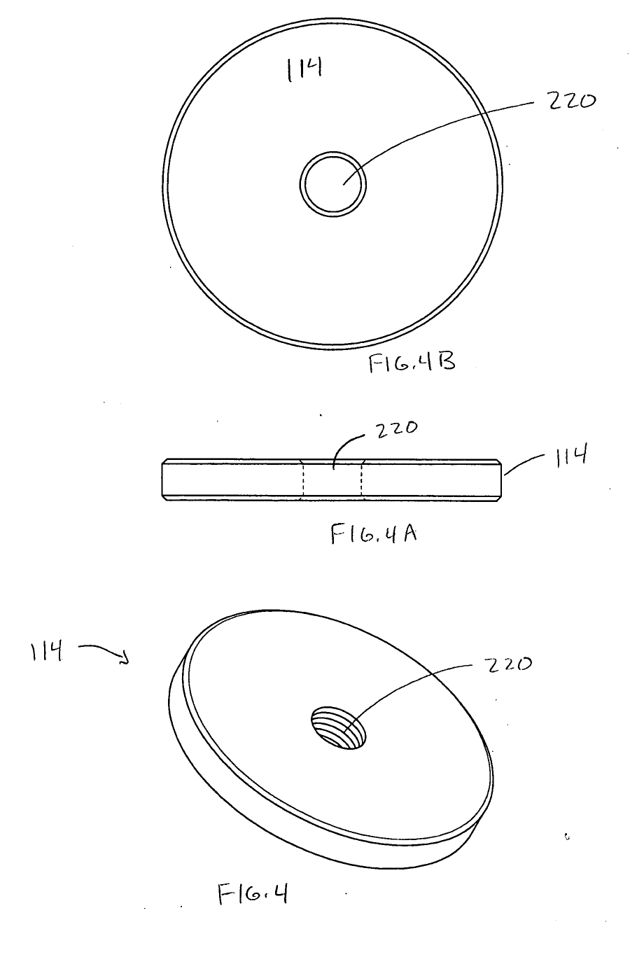

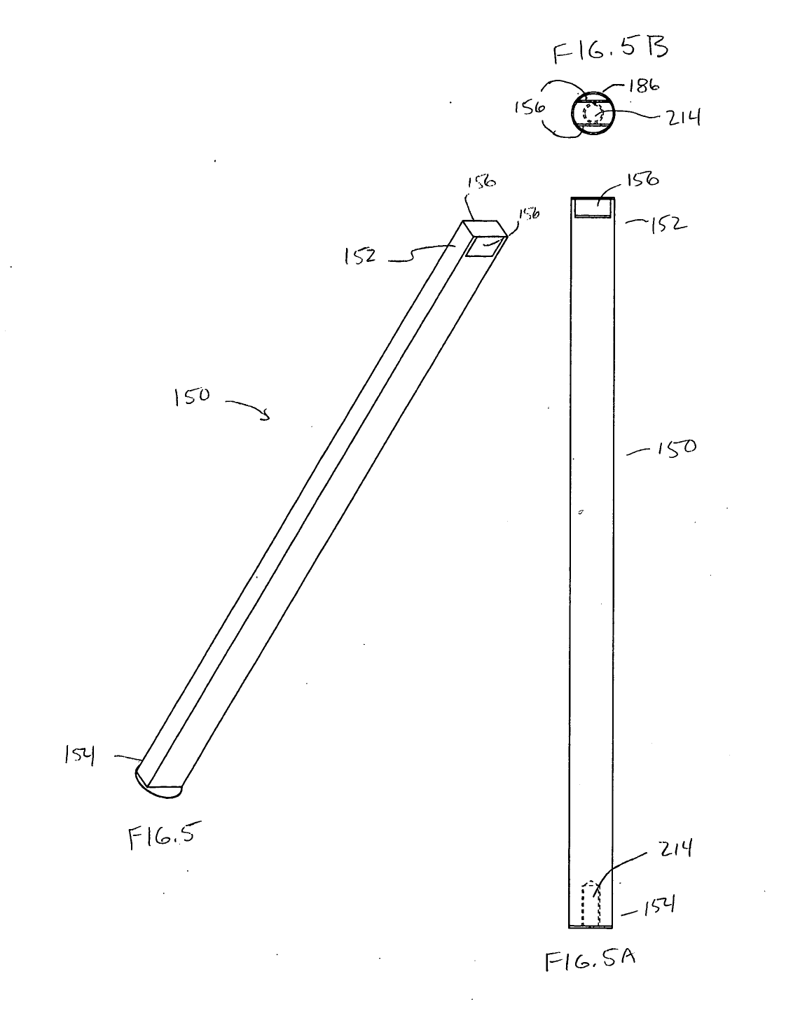

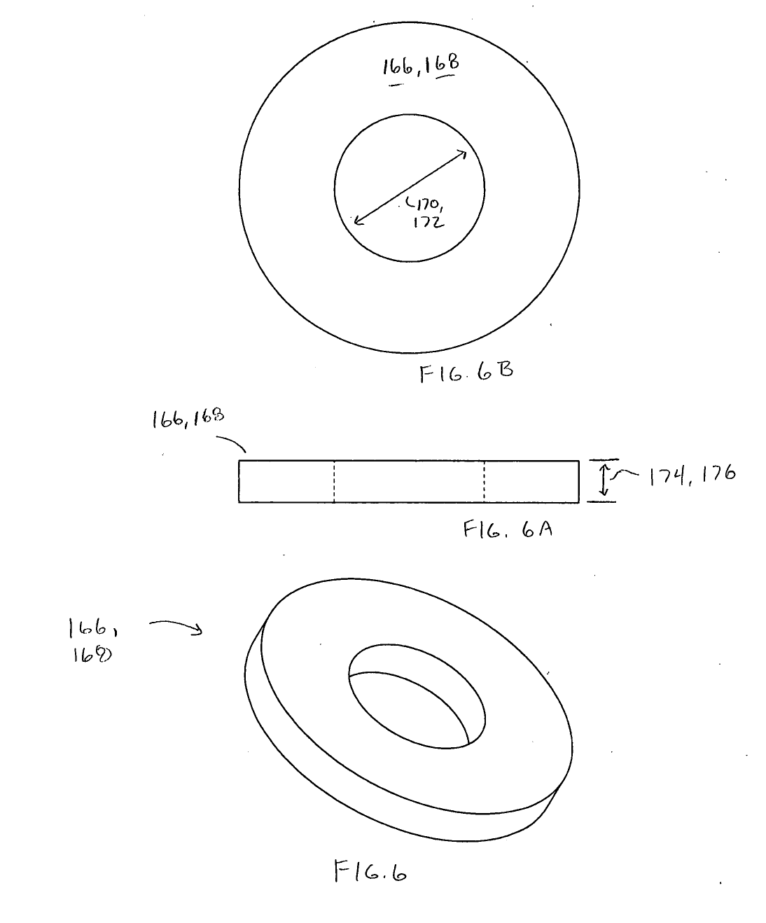

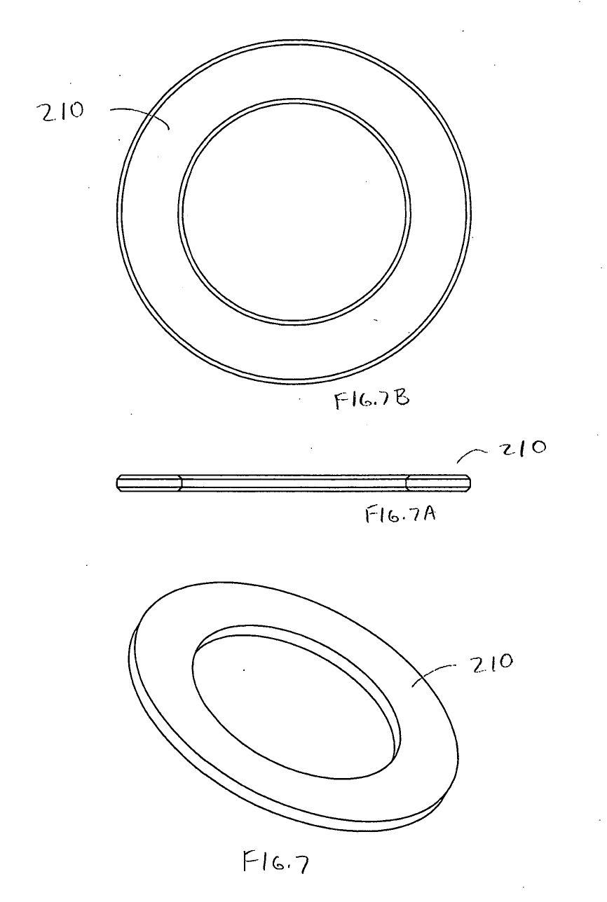

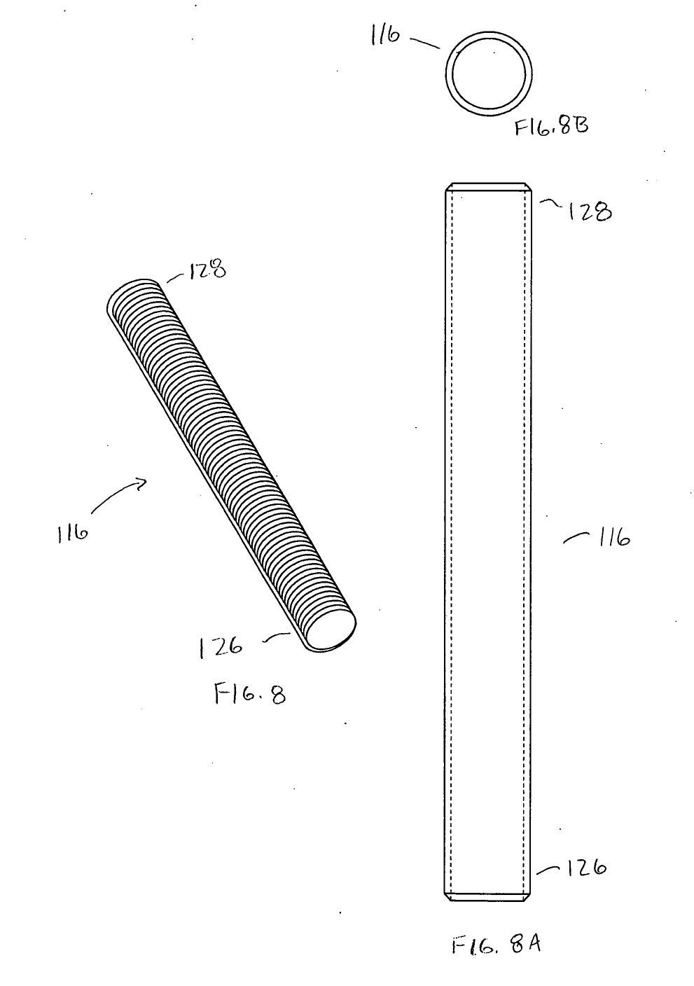

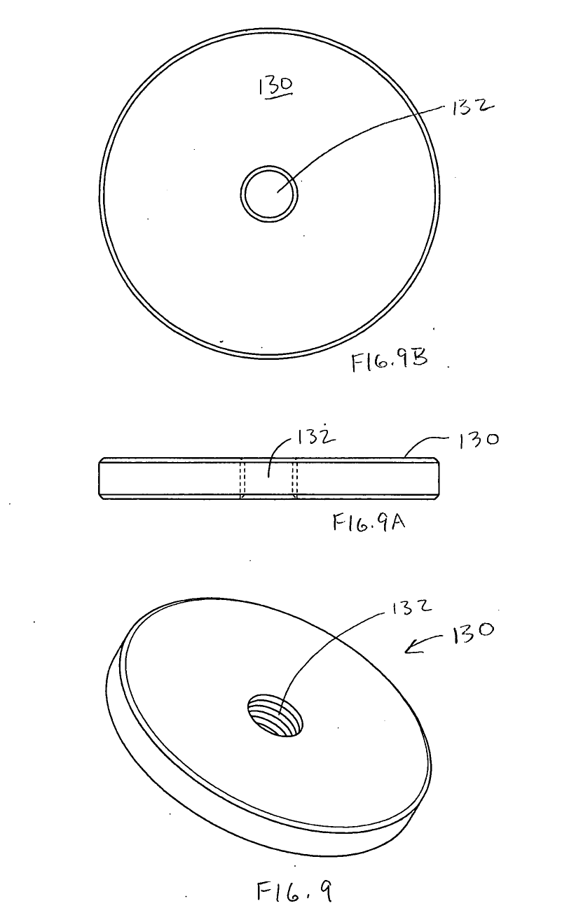

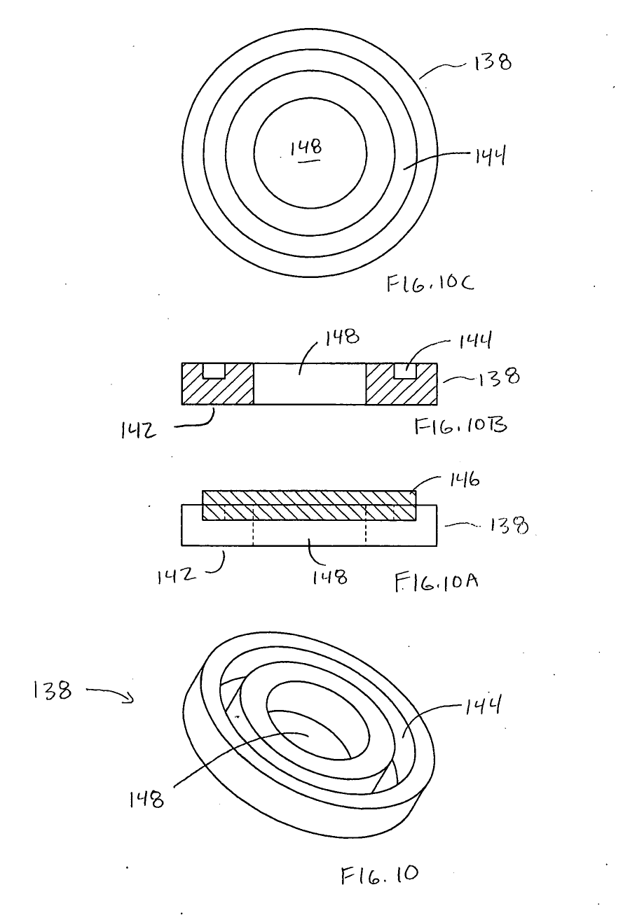

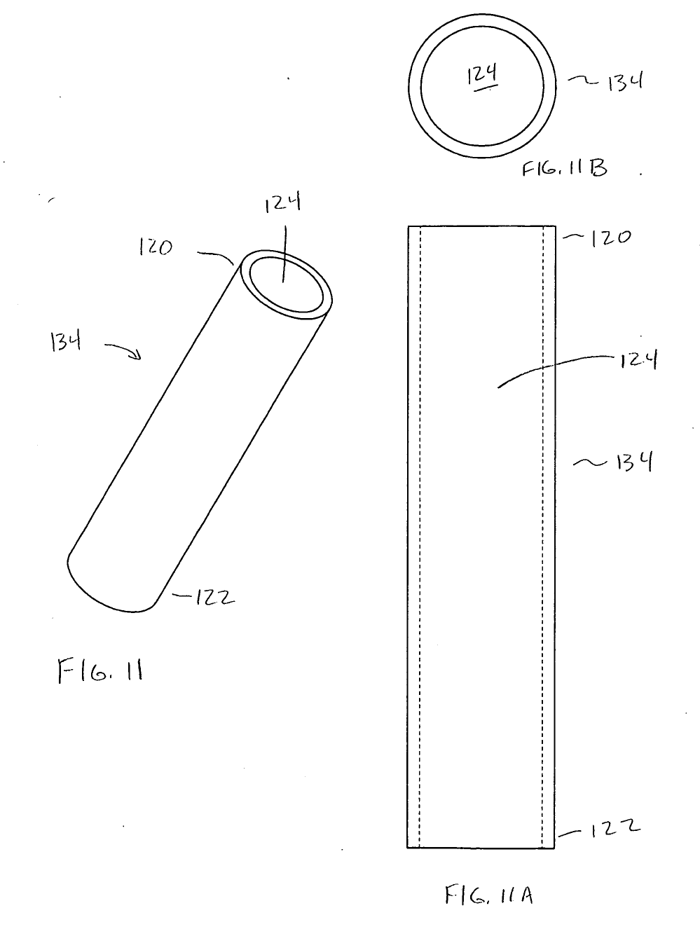

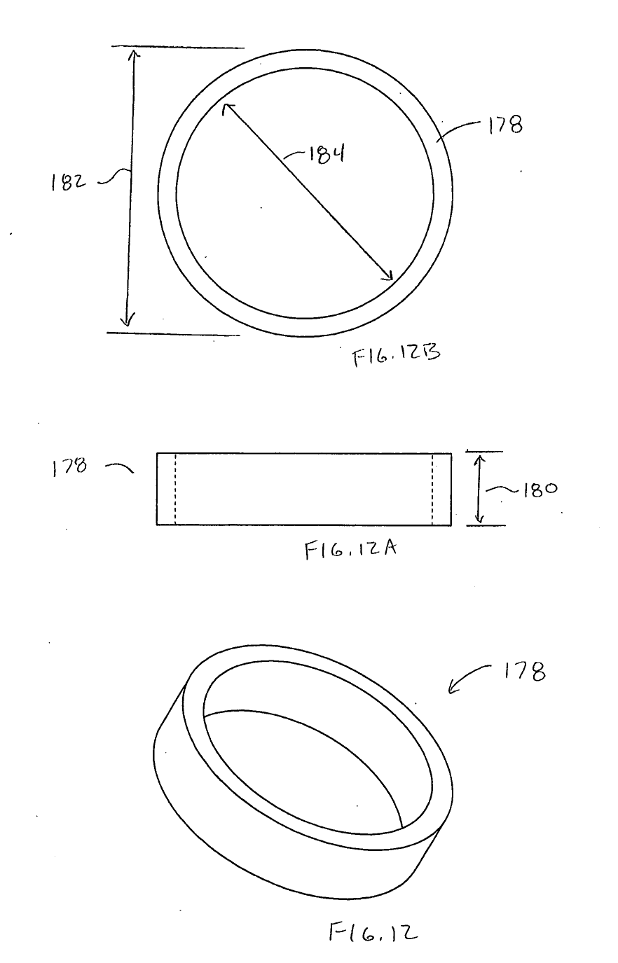

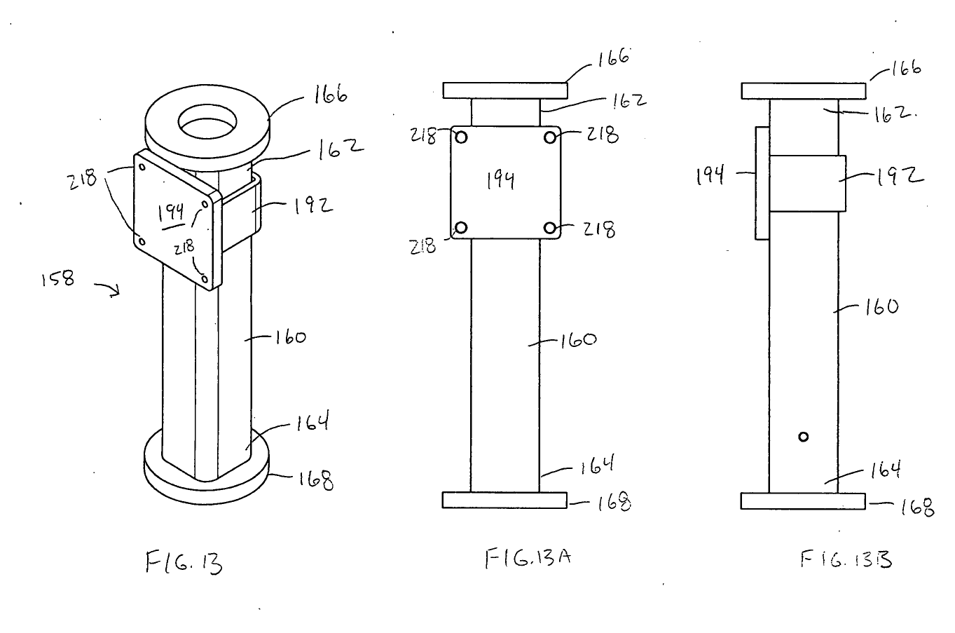

Referring to FIGS. 1-13 an embodiment of a material handling system 100 is shown, mounted to a milling machine M, having a frame F, a head H, and a table T. Base portion 110 is removably connected to machine frame F at the rear of the machine. In this embodiment, frame F includes an oil reservoir mounting flange A, which provides a convenient mounting point.

In the embodiment, base portion 110 includes stanchion 112, bottom plate 114, mounting stud 116, and base compression nut 118. Bottom plate 114 includes hole 220 for receiving mounting stud 116. Stanchion 112 includes stanchion tube 134 with first and second ends 120 and 122, respectively, and includes first centerline channel 124 extending from first to second ends 120 and 122, respectively. Mounting stud 116 is provided with threaded first and second portions, 126 and 128. In the embodiment, mounting stud 116 is a length of aft-thread, which provides infinite adjustability for clamping to a range of machines or brackets. Stanchion bottom flange 130 forms a closed end plate with centered receiving hole 132 for receiving mounting stud first threaded portion 126. In the embodiment receiving hole 132 is threaded to provide direct coupling of mounting stud 116 to bottom flange 130. Mounting stud first threaded portion 126 must be of sufficient length to provide a strong coupling to main shaft 150, preferably extending at least 2 inches (51 mm) beyond bottom flange 130 into centerline channel 124. Stanchion upper flange 138 is rigidly and concentrically connected to stanchion tube 134 at its first end. Stanchion upper flange 138 includes a first face 140 which goes against stanchion be first end 120 and an opposing second face 142, which includes a bearing race 144 for receiving a thrust bearing 146. In the embodiment thrust bearing 146 is a needle bearing, providing both thrust and radial support. Stanchion upper flange 138 is substantially torroidal with a center through passage 148 to insert stanchion main shaft upper bushing 224 to support main shaft 150.

Pivot post 158 includes a tube 160 with second centerline channel 222 extending from first to second ends 162 and 164, respectively, and corresponding first and second pivot post flanges 166 and 168 rigidly and concentrically connected at first and second ends 162 and 164. First and second pivot post flanges 166 and 168 include center through passages 170 and 172 having thicknesses 174 and 176 dimensioned to receive first and second main shaft bushings 178, such that the outer diameters 182 of shaft bushings 178 match the inner diameters 170 and 172, respectively, and the inner diameters 184 of shaft bushings 178 match the outside diameter 186 of main shaft 150. Main shaft bushings 178 fit tightly into flanges 166 and 168 so as to substantially prevent rotation of the bushings during operation, and the depth 180 of shaft bushings 178 is approximately equal to or less than the thickness of flanges 166 and 168. In the embodiment first and second main shaft bushings 166 and 168 are fabricated from brass, which is substantially softer than the material of main shaft 150 and readily replaceable. Other materials such as Teflon® coated steel may also be used to provide a self-lubricating surface.

Main shaft 150 includes a first end 152 and a second end 154, and has a circular cross section for most of its length. Main shaft first end 152 has opposing flats 156. Main shaft second end 154 includes a female threaded hollow bore 214 for mating with mounting stud first portion 126. In the embodiment, main shaft 150 is fabricated using a high strength steel allow, Acroloy ^{TM} 4140 TGP, and polished or chromed to reduce friction.

A third shaft main shaft bushing 178 is provided which inserts into base stanchion upper flange 138 to support main shaft 150.

Thrust washer 210 goes over main shaft first end 152 and rests on first main shaft bushing 178 and first pivot post flange 166. Set collar 188 clamps main shaft first end 152 below flats 156 to retain thrust washer 210 in place. In the embodiment thrust washer 210 is fabricated from brass, which is substantially softer than the material of main shaft 150 and first pivot post flange 166 and readily replaceable.

Jib arm 190 is rigidly connected to pivot post 158 and extends horizontally there from. In the embodiment, backstrap 192 is fixedly connected around pivot post tube 160 and mates with mounting plate 194 to provide a rigid connection point for jib arm 190. Gusset arms 212 are removably connected between jib arm 190 and pivot post 158 providing added support for jib arm 190.

Linear rail 196 is mounted to the bottom of jib arm 190 and extends along a portion of the length of jib arm 190. Shuttle 198 connects to linear rail 196 so as to be able to move along the length of linear rail 196.

Lifter 200 is removably connected to shuttle 198. In the embodiment, lifter 200 is a manual chainfall hoist connected to shuttle 198 using locking hook 202 or rotating clevis arrangement. Load handler 204 is flexibly connectable to lifter 200 using chains 206. In the embodiment, load handler 204 is a locking hook 208 attachable to an eyebolt on the load. Other lifter/load handler combinations may be used to customize the arrangement to the particular material and processing to be performed.

In operation, the material handling system is modular and easily assembled and disassembled for field use or to conserve machine shop space.

Base portion 110 is assembled and mounted to a convenient point on a machine, or on a truck other point for use at a construction site or other field location. Mounting stud first threaded portion 126 is threaded through stanchion bottom flange hole 132 so it projects beyond bottom flange 130 for coupling to main shaft 150.

When stanchion tube second end is mated to bottom flange 130 then mounting stud 116 projects into stanchion tube centerline channel 124. Stanchion upper flange 138 is mated to stanchion tube first end 120. In the embodiment, stanchion 112 is pre-assembled by welding stanchion bottom and upper flanges 130 and 138, respectively, to stanchion tube 134. Third main shaft bushing 178 is installed into stanchion upper flange 138.

Base portion 110 may be damped to its machine or bracket by inserting bottom plate 114 over mounting stud second threaded portion 128 and securing it with base nut 118 to hold the machine frame or bracket portion in compression. In the embodiment, mounting stud 116 is 0.75 inch (20 mm) steel allthread, and flanges and bottom plate are fabricated from 9/16 inch (14.3 mm) steel to provide adequate strength.

Mainshaft 150 is installed by inserting it through upper flange 138 with third main shaft bushing 178 so that mainshaft second end 154 can be threaded onto mounting stud first threaded portion 126 projecting into stanchion tube centerline channel 124. Mainshaft 150 is highly torqued against bottom flange 130 using main shaft flats 156 and a large torque wrench or other suitable tool.

Pivot post 158 may be assembled separately by mating pivot post tube 160 to pivot post first and second end flanges 166 and 168 at first and second ends 162 and 164, respectively. First and second main shaft bushings 178 are installed into end flanges 166 and 168. Bearing 146 is installed in bearing race 144 and pivot post 158 can then be slipped over main shaft 150 until it rests on bearing 146. Bearing 146 projects slightly above bearing race 144 so that stanchion upper flange 138 and pivot post second end flange 168 define a very narrow gap, but do not contact each other. Thrust washer 210 is then inserted over mainshaft first end 152 to rest on pivot post first end flange 166 and first shaft main shaft bushing 178. Set collar 188 is installed over mainshaft first end 152 and against thrust washer 210 to retain the thrust washer 210 and prevent vertical displacement of pivot post 158. In practice, stanchion 112 and pivot post 158 may be pre-assembled and joined together to be mounted as a single unit, or may be disassembled for separate stowage and carrying, so that individuals can manipulate the loads with relative ease. In the embodiment all flanges are welded to their respective tube ends for increased strength.

Gusset arms 212 are bolted to pivot post 158, and backstrap 192 and jib arm mounting plate 194 are mounted onto pivot post 158 in preparation for mounting jib arm 190. In the embodiment, backstrap 192 and mounting plate 194 are permanently affixed to pivot post 158 by welding. In the embodiment jib arm 190 is provided with a corresponding mounting flange 216 with bolt holes 218 for ease of alignment. In the embodiment, linear rail 196 with shuttle 198 is pre-mounted to the underside of jib arm 190. Lifter 200 is then connected to shuttle 198, and load handler 204 is connected to flexible connector 206, which in the embodiment is a chain suspended from a chain hoist 200.

Pivot post 158 with jib arm 190 freely rotates about mainshaft 150, while mainshaft 150 and base portion 110 remain fixed in relation to the machine or bracket to which it is mounted.

In use, with a material handling system 100 mounted to a stand alone milling machine, the user may rotate jib arm 190 and slide shuttle 198 to any point within reach of the jib arm, secure a load such as a motor using an appropriate load handler arrangement, lift the load using lifter 200, and rotate/slide the load to the milling machine table with ease.

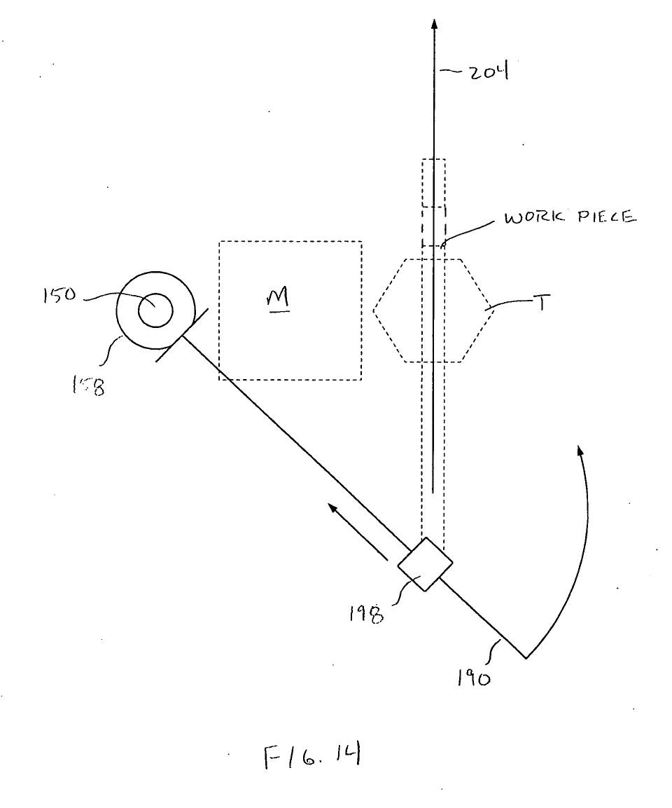

Referring to FIG. 14, the inventor has discovered a unique advantage with this material handling system, however. The inventor has found that long work pieces can be easily fed through such a milling machine while maintaining an even depth and shape of cut in the work piece. With the work piece supported and gripped by load handler 204 at its free end, the operator can push the work piece across the milling machine table at the desired rate. Jib arm 190 will simply rotate freely about its axis while shuttle 198 moves along linear rail 196, so that load handler 204 tracks a linear path through space. This allows a single machinist to, for example, mill a uniform keyway or lubrication channel along the length of a long pump shaft, without the risk that tipping or yaw of the shaft which can lead to non-uniform depth and cross-sections. By way of another example, carpenters can feed long work pieces into woodworking machinery without the need for large tables to support the free end of the piece as it is fed through.

Those skilled in the art will recognize that numerous modifications and changes may be made to the preferred embodiment without departing from the scope of the claimed invention. It will, of course, be understood that modifications of the invention, in its various aspects, will be apparent to those skilled in the art, some being apparent only after study, others being matters of routine mechanical, chemical and electronic design. No single feature, function or property of the preferred embodiment is essential. Other embodiments are possible, their specific designs depending upon the particular application. As such, the scope of the invention should not be limited by the particular embodiments herein described but should be defined only by the appended claims and equivalents thereof.

I claim:

1. A modular material handling system, comprising:
A base portion removably connectable to a machine tool frame, said base portion including:
a hollow stanchion having opposing first and second flanged ends and a first centerline channel extending there between, said first flanged end further having a central circular through passage and a face configured to receive a thrust bearing, said second flanged end to go against a portion of said machine frame and further including a closed end plate having a first receiving hole there through with diameter less than a main shaft diameter;
a stanchion main shaft upper bushing to insert into said stanchion first end central through passage;
a bottom compression plate to go against a portion of said machine frame in opposing manner to said stanchion second flanged end, said bottom compression plate having a second receiving hole there through;
an elongated mounting stud having opposing first and second threaded ends, said mounting stud to insert through said first and second receiving holes and said machine frame portion; and,
a base compression nut to couple to said mounting stud second threaded end against said bottom compression plate;
a pivot post assembly to couple to said stanchion, said pivot assembly comprising a hollow pivot post having opposed first and second flanged ends and a second centerline channel extending there between, each of said first and second pivot post flanged ends including a central circular through passage, and said second pivot post flanged end further including a face configured to receive a thrust bearing; and first and second pivot post main shaft bushings insertable into said first and second pivot post central through passages, respectively;
a thrust bearing to couple said base portion and said pivot post assembly between said stanchion first flange face and said pivot post second flange face;
an elongated main shaft having a first end with opposing flats, a second end with a female threaded hole, and a circular cross section, said main shaft to insert through said first and second centerline channels within said main shaft bushings and said shaft second end going against said stanchion end plate to couple said female threaded hole with said mounting stud first threaded end through said first receiving hole, said shaft first end extending beyond said pivot post first end;
a thrust washer to insert over said man shaft first end onto said pivot post first flanged end and said main shaft bushing within said pivot post first flanged end through passage;
a set collar to insert over said main shaft first end against said thrust washer and secure to said main shaft; and,
an elongated arm to rigidly couple to said pivot post so as to extend substantially normal from said pivot post, said elongated arm to receive a shuttle.

2. A system as in claim 1, further comprising a shuttle movably coupled to said arm, said shuttle movable along at least a portion of the length of said arm, said shuttle configured to receive a load lifting mechanism.

3. A system as in claim 2, further comprising a linear rail mounted along at least part of the length of said elongated arm, wherein said shuttle is mounted to said linear rail to move along said linear rail.

4. A system as in claim 2, further comprising a lifting mechanism coupled to said shuttle.

5. A system as in claim 1, further comprising one or more gusset arms to couple between said elongated arm and said pivot post.

6. A system as in claim 1, wherein said base portion further comprises a stanchion main shaft lower bushing to insert into said first centerline channel against said end plate and to receive said main shaft second end therein.
